(19) United States
(12) Patent Application Publication
(10) Pub. No.: US 2026/0228999 A1
(43) Pub. Date: Aug. 6, 2026

(54) OBJECT DETECTION SYSTEM AND METHOD

(71) Applicant: KROMEK LIMITED, Sedgefield County Durham (GB)

(72) Inventors: Peter Sebastian Greenwood Rhodes, Wallsend (GB); Ra'ad Munir David Mahmoud, Knutsford (GB); David James Tupman, Sedgefield (GB); Robert Anthony Taggart, Durham (GB)

(21) Appl. No.: 19/155,188

(22) PCT Filed: Nov. 28, 2023
(86) PCT No.: PCT/GB2023/053081

§ 371 Date: Aug. 8, 2025

(30) Foreign Application Priority Data
Feb. 9, 2023 (GB) 2301808.8

(51) Int. Cl. G06V 10/25; G06N 3/0464; G06V 10/74; G06V 10/764; G06V 10/77; G06V 10/82

(52) U.S. Cl. CPC G06V 10/25; G06N 3/0464; G06V 10/761; G06V 10/764; G06V 10/7715; G06V 10/82; G06V 2201/07

(57) ABSTRACT

An object detection system comprising a computing device in communication with an imaging device, wherein the computing device is configured to: collect, from the imaging device, a first image captured along a first image axis; collect, from the imaging device, a second image captured along a second image axis; generate one or more first feature maps and one or more second feature maps for the first image and the second image respectively; determine one or more first region proposals and one or more second region proposals based on the one or more first feature maps and the one or more second feature maps respectively; select one or more first regions of interest from the one or more first region proposals; select one or more second regions of interest from the one or more second region proposals; match the first regions of interest with corresponding second regions of interest; and determine the presence of an object of concern based on the combined region of interest and the feature maps.

### FIELD OF THE DISCLOSURE

The present disclosure relates to a method for detecting objects of concern. In particular, the present disclosure relates to a method and system for determining the presence of an object of concern within an object under inspection.

### BACKGROUND TO THE DISCLOSURE

The automated detection and localisation of objects, such as explosive objects, in cabin baggage has been a long-standing challenge in the field of aviation security.

Existing approaches may utilise computed tomography (CT) scanners configured to capture a full 360-degree view of the cabin baggage. However, whilst CT scanners are powerful, there are also numerous disadvantages associated with them, including: size; weight; power requirements; and maintenance requirements. Furthermore, CT scanners are expensive in comparison to other scanners, such as dual-view X-ray scanners. That being said, dual view X-ray scanners may provide less information than CT scanners, and thus far, there have been difficulties in developing an algorithm which can successfully automate the detection of objects of concern using the dual view system.

A particularly challenging problem facing development of suitable algorithms for dual view X-ray scanners (and to some extent, CT scanners) relates to the detection of “sheet” explosive objects. Sheet explosive objects are explosive objects having a shorter third dimension relative to a first dimension and a second dimension. These sheet explosives may be missed by single-view algorithms because the short third dimension may lead to a low attenuation of X-rays when observed from a perspective maximising their projection area. For example, if the sheet explosive object is lying flat on the scanning belt, it may cover a large area but may be difficult to detect due to a low attenuation of X-rays when viewed from a top-down view. This may nullify even neural-network based object recognition algorithms which operate on individual views in isolation.

The present disclosure has been devised to mitigate or overcome at least some of the above-mentioned problems.

### SUMMARY OF THE DISCLOSURE

In accordance with a first aspect of the present disclosure, there is provided an object detection system comprising a computing device in communication with an imaging device, wherein the computing device is configured to: collect, from the imaging device, a first image captured along a first image axis; collect, from the imaging device, a second image captured along a second image axis; generate one or more first feature maps and one or more second feature maps for the first image and the second image respectively; determine one or more first region proposals and one or more second region proposals based on the one or more first feature maps and the one or more second feature maps respectively; select one or more first regions of interest from the one or more first region proposals; select one or more second regions of interest from the one or more second region proposals; match the first regions of interest with corresponding second regions of interest; and determine the presence of an object of concern based on the combined region of interest and the feature maps.

The term “image axis” may be understood as, for a given image, an imaginary straight line drawn through a central point of the imaged region from a focus point of the imaging device or system creating that image in the case of an imaging system employing a converging or diverging set of captured rays; or parallel to the captured rays, in the case of an imaging system employing parallel captured rays. For example, in an imaging system employing a point source of radiation and an extended capture device, the image axis may be the straight line drawn from the centre of the imaged region through the point source. In this way, the “first image axis” is such a defined axis for the first image, and the “second image axis” is such a defined axis for the second image.

The computing device of the present system may identify an object of concern, such as an explosive object, in an object under inspection, such as an enclosed volume, for example an item of baggage. In particular, the present system may collect or receive a bi-channel image from two views of the imaging device, although it will be appreciated that more than two views may be utilised. The system may produce one or more regions of interest in each view, match regions of interest of each view, and combine the matched regions of interest. The resultant combined region of interest may then be used to determine the presence of the object of concern in the object under inspection.

The present system may find particular use with respect to identifying sheet explosive objects because a low attenuation along the first image axis may imply significant attenuation along the second image axis if the second image axis is angularly offset in relation to the first image axis. Advantageously, the present system may achieve high levels of object detection.

In some embodiments, the imaging device is a dual view imaging device. In this way, the imaging device may be capable of capturing the first image and the second image. Advantageously over computed tomography systems, the imaging device may capture as few as 2 images and may operate only on these images, thereby reducing the required computational complexity.

It will be appreciated that the present system is not limited to determining the presence of an object of concern based on two images or views, and that any number of images or views may be utilised.

Preferably, the imaging device is an x-ray imaging device. In this way, the first and second images may comprise pixel values indicative of a received intensity of x-rays at spatial locations of the imaging device. Advantageously, the x-ray imaging device may capture images comprising an object of concern within the object under inspection.

Preferably, the first image is a two-dimensional image having a first dimension and a second dimension; and the second image is a two-dimensional image having the second dimension and a third dimension. For example, the first dimension may correspond to an x-dimension of the object of concern, the second dimension may correspond to a y-dimension of the object of concern, and the third dimension may correspond to a z-dimension of the object of concern.

Preferably, the first and second images are captured such that the first image axis is at an angular offset to the second image axis. In some embodiments, the angular offset is such that the first image axis is orthogonal to the second image axis. However, it will be understood by the skilled person that the angular offset does not need to be orthogonal, only that an angular offset is present. Advantageously, the imaging device may capture images having different views of the object under inspection.

Preferably, the one or more first and second feature maps are generated by inputting the first and second images to at least one Convolutional Neural Network (CNN), said CNN being configured to generate the one or more first and second feature maps. Preferably, the CNN is pre-trained. Preferably, the CNN comprises a first image branch and a second image branch. Preferably, the first image branch is pre-trained using images corresponding to the first view. Preferably, the second image branch is pre-trained using images corresponding to the second view. In this way, the CNN may generate the one or more feature maps, each feature map providing an indication of the presence of a part of an object of concern. Preferably, the Convolutional Neural Network is a residual neural network such as ResNet. An advantage with using a CNN instead of non-convolutional networks may be that CNNs are less computationally expensive and produce feature maps of equal to or greater quality.

Preferably, the one or more first and second region proposals are determined by inputting the first and second feature maps to a Region Proposal Network (RPN), said RPN being configured to generate the one or more first and second region proposals based on the first and second feature maps, respectively. Preferably, the one or more potential first and second region proposals each comprise a corresponding target object probability, indicative of the presence of a target object, said target object being an object of concern. In this way, the RPN may provide a set of region proposals corresponding to the first image, along with a confidence score indicating a likelihood of the presence of an object of concern in said region. Similarly, the RPN may provide a set of region proposals corresponding to the second image, along with a confidence score indicating a likelihood of there being an object of concern in said region. The confidence score may be a percentage confidence score, although it will be appreciated that any suitable confidence score may be used. Use of the RPN may advantageously provide a means for providing regions likely to have an object of concern to, for example, a classifier, whilst not providing regions that may be empty or unimportant.

Preferably, the one or more first and second regions of interest are selected by applying a filter to the one or more first and second region proposals. In some embodiments, the filter is a non-maximum suppression filter. In this way, the non-max suppression filter may pass forward region proposals in a set of overlapping region proposals having a highest confidence score, while not providing other region proposals having a lower confidence score. Advantageously, a computational cost may be reduced.

Preferably, matching the first regions of interest with the corresponding second regions of interest is based on a shared second dimension.

In some embodiments, matching the first regions of interest with the corresponding second regions of interest comprises, for each possible match: determining, for the first region of interest, a minimum axis value and a maximum axis value of the second dimension; determining, for the second region of interest, a minimum axis value and a maximum axis value of the second dimension; determining a minimum axis value difference between the minimum axis value of the first region and a minimum axis value of the second region; determining a maximum axis value difference between the maximum axis value of the first region and a maximum axis value of the second region; determining a sum of the minimum axis value difference and the maximum axis value difference; and matching the first region of interest with the second region of interest based on a matching condition being met. In this way, regions of interest of the different images may be automatically matched.

In some embodiments, the matching condition is a minimisation of the sum. Advantageously, the matching may be achieved with minimal computational expense. Advantageously, the matching condition may provide matches of regions of interest having a higher degree of co-spatiality.

Preferably, the minimum axis value of each match of first and second regions are determined by averaging, via the mean, the minimum value for the first region and the minimum value for the second region. Further preferably, the maximum axis value of each match of first and second regions are determined by averaging, via the mean, the maximum value for the first region and the maximum value for the second region.

Preferably, the presence of an object of concern is determined by: providing, to a classifier: the one or more first regions of interest; the one or more first feature maps; the one or more second regions of interest; and the one or more second feature maps; cropping and dynamically pooling, by the classifier, the one or more first regions of interest from the one or more first feature maps, thereby generating one or more first pooled regions of interest; cropping and dynamically pooling, by the classifier, the one or more second regions of interest from the one or more second feature maps, thereby generating one or more second pooled regions of interest; convolving, by the classifier, the one or more first pooled regions of interest with a 2-dimensional convolution block; convolving, by the classifier, the one or more second pooled regions of interest with a 2-dimensional convolution block; concatenating, by the classifier, each of the one or more convolved first pooled regions of interest with each of the convolved second pooled regions of interest; flattening, by the classifier, each of the concatenated and convolved first and second pooled regions of interest; and classifying, by the classifier, each of the flattened, concatenated and convolved first and second pooled regions of interest; wherein each classification provides an indication as to whether and where an object of concern is present in the captured first and second images.

Preferably, the cropping and dynamical pooling steps are achieved via spatial pyramid pooling.

In some embodiments, the first and second images are captured simultaneously. In this way, the regions of interest may be more reliably matched in particular circumstances, such as instances wherein the object of concern and/or the object under inspection deforms between captures.

In some embodiments, the second image is captured at an offset to the first image. The offset may be along a shared dimension. The shared dimension offset may be a temporal offset. For example, the temporal offset may be 1.5 seconds. In these embodiments, the computing device may be configured to realign the first and second images such that they match along the second dimension.

In some embodiments, the object of concern is an explosive object.

In accordance with a second aspect of the present disclosure, there is provided an object detection method performed by a computing device, comprising the steps of: collecting, from an imaging device, a first image captured along a first image axis; collecting, from the imaging device, a second image captured along a second image axis; generating one or more first feature maps and one or more second feature maps for the first image and the second image respectively; determining one or more first region proposals and one or more second region proposals based on the one or more first feature maps and the one or more second feature maps respectively; selecting one or more first regions of interest from the one or more first region proposals; selecting one or more second regions of interest from the one or more second region proposals; matching the first regions of interest with corresponding second regions of interest; and determining the presence of an object of concern based on the combined region of interest and feature maps.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art, in light of the description, the claims, and the drawings of the present disclosure. The foregoing general description and the following detailed description are exemplary and explanatory only and are not restrictive of the claims.

### BRIEF DESCRIPTION OF THE DRAWINGS

One or more embodiments of the disclosure will now be described, by way of example only, with reference to the accompanying drawings, in which:

FIG. 1 is a schematic view of an object detection system in accordance with a second aspect of the present disclosure;

FIG. 2 is a representation of a flow diagram of an object detection method in accordance with a first aspect of the present disclosure, using the system of FIG. 1;

FIG. 3 is a representation of a flow diagram of a feature map generation protocol using the system of FIG. 1;

FIG. 4 is a representation of a flow diagram of a region proposal protocol using the system of FIG. 1; and

FIG. 5 is a representation of a flow diagram of an object presence detection method using the system of FIG. 1.

### DETAILED DESCRIPTION

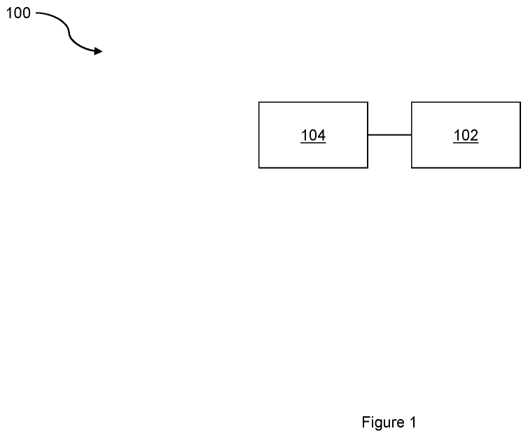

FIG. 1 is a schematic view of an object detection system 100 for detecting the presence of an object of concern within an object under inspection, such as an enclosed volume. In the present example, the system is for detecting the presence of an object of concern, such as an explosive object, within an object under inspection, such as an item of baggage.

The system 100 comprises a computing device 102 in communication with an imaging device 104.

The computing device 102 is configured to execute steps of the methods disclosed herein. The computing device 102 comprises one or more electrical components, such as a processor (not shown), a transmitter (not shown), a receiver (not shown), and any other suitable electrical component. The computing device 102 comprises, or is in communication with, a Convolutional Neural Network (CNN). The CNN is pre-trained. The computing device 102 also comprises, or is in communication with, a Region Proposal Network (RPN). The RPN is pre-trained.

The imaging device 104 is a dual view X-ray imaging device 104 configured to capture one or more images of the item of baggage. In particular, the imaging device 104 is configured to capture a first image and a second image of the item of baggage.

The first and second images are captured such that a first image axis is at an angular offset to a second image axis.

The term “image axis” may be understood as, for a given image, an imaginary straight line drawn through a central point of the imaged region from a focus point of the imaging system creating that image in the case of an imaging system employing a converging or diverging set of captured rays; or parallel to the captured rays, in the case of an imaging system employing parallel captured rays. For example, in an imaging system employing a point source of radiation and an extended capture device, the image axis is the straight line drawn from the centre of the imaged region through the point source. In this way, the “first image axis” is such a defined axis for the first image, and the “second image axis” is such a defined axis for the second image.

For example, the first image axis and the second image axis are may be orthogonal, although this is not a necessity. For example, the first image axis may be a vertical axis, in that the first image axis is substantially vertical with respect to the item of baggage. The second image axis may be a horizontal axis, in that the second image axis is substantially horizontal with respect to the item of baggage. In other words, the angular offset may be 90 degrees. Accordingly, in this example the images of the item of baggage may be taken along orthogonal axes. However, it will be appreciated that any non-zero angular offset may be present.

The first and second images are both two-dimensional (2D) images. The first image has a first and second dimension. For example, when the first image axis is the vertical axis, the first image corresponds to a width dimension and a length dimension of the volume of the item of baggage. When the second image axis is the horizontal axis, the second image has a second and third dimension. For example, the second image has dimensions corresponding to the length dimension and a height axis of the item of baggage.

The computing device 102 is configured to receive spectral data from the dual-view X-ray imaging device 104 and perform an object detection method 200 in order to determine the presence of the explosive object in the item of baggage.

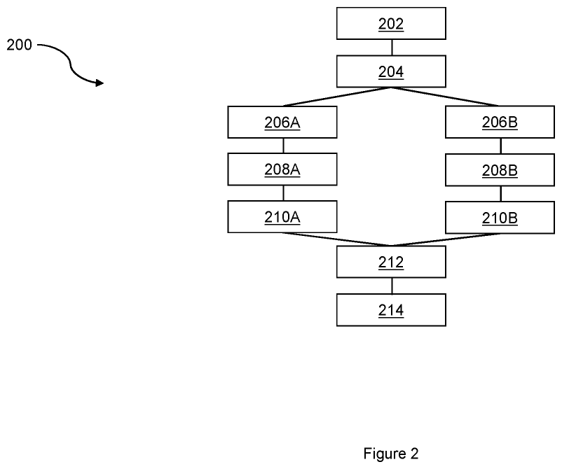

FIG. 2 is an object detection method 200 performed by the computing device 102 of the system 100. The method 200 is configured to determine the presence of an object of concern, such as an explosive object, within an object under inspection, such as an item of baggage.

In a first step 202, the computing device 102 collects, from the imaging device 104, a first image of the object under inspection. The first image is captured along a first image axis. This first image has an image x and an image y axis. In the present example, the first image axis is a vertical axis, in that the first image axis is substantially vertical with respect to the object under inspection. In this example, the image x-axis corresponds to a width dimension of the volume and the image y-axis corresponds to a length dimension of the volume.

In step 204, the computing device 102 collects, from the imaging device 104, a second image of the object under inspection. The second image is captured along a second image axis, wherein the second image axis is at an angular offset to the first image axis of 90 degrees. In particular, the second image axis is a horizontal axis, in that the second image axis is substantially horizontal with respect to the object under inspection. This second image also has an image x and an image y axis. In the second image, the image x-axis corresponds to the height dimension of the volume and the y-axis corresponds to a length dimension of the volume.

The skilled person will appreciate that the orthogonality of the first and second detector axes is by way of example only, and the image x-axis of the first image and the image x-axis of the second image may each correspond to linear sums of the width and height dimensions of the volume. In the present example, the image x-axis of the first image corresponds to only the width dimension of the volume, while the image x-axis of the second image corresponds to only the height dimension of the volume.

In step 206A, the computing device 102 generates one or more first feature maps based on the first image.

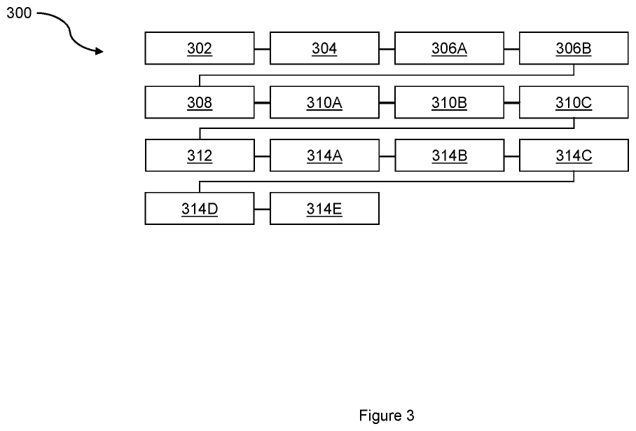

In particular, the computing device 102 generates a first image tensor of the first image. The skilled person will appreciate that the first image tensor may be a tensor of any dimension suitable for representing the first image. For example, if the first image is a greyscale image, the first image tensor is a 2-dimensional image tensor. The computing device 102 then inputs the first image tensor into the Convolutional Neural Network (CNN). The CNN is configured to execute a Feature map generation protocol 300 to generate the first feature maps. The Feature map generation protocol 300 is depicted in FIG. 3 and further detail can be found below.

In step 206B, the computing device 102 generates one or more second feature maps based on the second image.

In particular, the computing device 102 generates a second image tensor of the second image. The skilled person will appreciate that the second image tensor may be a tensor of any dimension suitable for representing the second image. For example, if the second image is a greyscale image, the second image tensor is a 2-dimensional image tensor. The computing device 102 then inputs the second image tensor into the CNN. The CNN is configured to execute the Feature map generation protocol 300 to generate the second feature maps.

In step 208A, the computing device 102 determines one or more first region proposals based on the one or more first feature maps. Step 208A is configured to identify areas in the one or more first feature maps that may contain an object of concern.

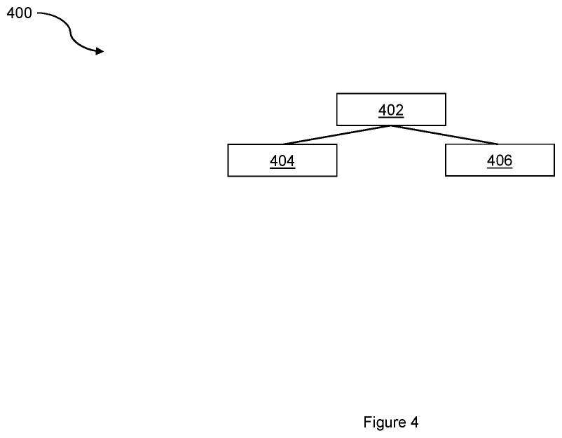

In particular, the computing device 102 inputs the first feature maps into the Region Proposal Network (RPN). The RPN is configured to execute a region proposal protocol 400 to generate the first region proposals. The region proposal protocol 400 is depicted in FIG. 4 and further detail can be found below.

In step 208B, the computing device 102 determines one or more second region proposals based on the one or more second feature maps. Step 208B is configured to identify areas in the one or more second feature maps that may comprise an object of concern.

In particular, the computing device 102 inputs the second feature maps into the RPN. The RPN is configured to execute the region proposal protocol 400 to generate the second region proposals.

In step 210A, the computing device 102 selects one or more first regions of interest from the one or more first region proposals. In particular, the computing device 102 applies a non-max suppression to determine the first region proposals that meet a threshold overlap score.

In step 210B, the computing device selects one or more second regions of interest from the one or more second region proposals. In particular, the computing device 102 applies a non-max suppression to determine the second region proposals that meet a threshold overlap score.

In step 212, the computing device 102 matches the first regions of interest with corresponding second regions of interest. In particular, for each of the first regions of interest, a maximum and a minimum y-axis value is determined. Similarly, a maximum and a minimum y-axis value is determined for each of the second regions of interest.

The computing device 102 determines a minimum difference for each potential match of regions of interest. That is, the computing device 102 determines a difference between the minimum y-axis value of one of the first regions of interest and each of the second regions of interest. The computing device 102 also determines a difference between the maximum y-axis value of the same one of the first regions of interest and each of the second regions of interest. The computing device 102 repeats this for difference determination for all of the first regions of interest in relation to the second regions of interest. The difference is the sum of the minimum difference and the maximum difference. Each of the first regions of interest is matched with a respective second region of interest based on the difference, wherein the matching is according to the minimum difference.

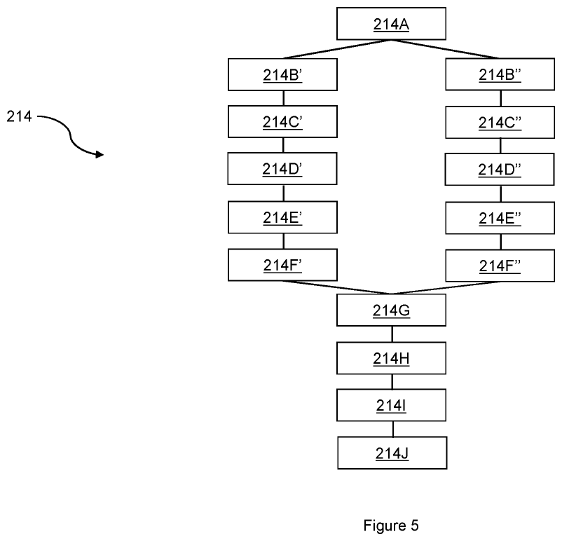

In step 214, the computing device 102 determines the presence of an object of concern, such as the explosive object, based on the combined or matched region of interest and the feature maps. The computing device 102 determines the presence of the object of concern following the object presence determination method 214 shown in FIG. 5.

Accordingly, the system 100 determines the presence of an object of concern, such as an explosive object, within an object under inspection, such as an item of baggage, using two or more angularly offset images captures by the imaging device 104.

FIG. 3 shows the feature map generation protocol 300. The feature map generation protocol 300 comprises a preparation portion 302; a first convolution block 304, two first identity sub-blocks 306A, 306B in sequence, a second convolution block 308, three second identity sub-blocks 310A, 310B, 310C in sequence, a third convolution block 312, and five third identity sub-blocks 314A, 314B, 314C, 314D, 314E in sequence.

In the preparation portion 302 of the CNN protocol, the CNN is configured to receive the image tensor and apply a zero padding to the image tensor. The zero padding is configured to provide a means for preserving the original size of the input tensor following a convolution of the image tensor. Next, the CNN convolves the padded image tensor using one or more filters. In the present example, the CNN convolves the padded image tensor with 64 7 by 7 filters having a stride of 2 so as to identify larger features of the image. This convolution step produces 64 feature maps. The CNN subsequently applies a batch normalization to the convolved image tensor so as to prevent a gradient imbalance. The CNN subsequently applies a rectified linear unit (ReLU) activation to the convolved image tensor. In a final step of the preparation portion 302, the CNN applies a max pooling to the normalized image tensor so as to reduce a size of the normalized image tensor. In the present example, the max pooling is a 3 by 3 pooling filter having a stride of 2. The preparation portion 302 provides a second input tensor to the first convolution block 304.

In the first convolution block 304, the CNN applies a first convolution to the second input tensor, the first convolution comprising convolving the second input tensor with 64 1 by 1 filters having a stride of 1, thereby generating a first convolved tensor. This convolution step produces 64 feature maps. The CNN applies a first batch normalization and ReLU activation to the first convolved tensor, thereby generating a first normalized tensor. The CNN applies a second convolution to the first normalized tensor, the second convolution comprising convolving the first normalized tensor with 64 3 by 3 filters having a stride of 1 and zero-padding to the same size as the first normalised tensor, thereby generating a second convolved tensor. This convolution step produces 64 feature maps. The CNN applies a second batch normalization and ReLU activation to the second convolved tensor, thereby generating a second normalized tensor. The CNN applies a third convolution to the second normalized tensor, the third convolution comprising convolving the second normalized tensor with 256 1 by 1 filters having a stride of 1, thereby generating a third convolved tensor. This convolution step produces 256 feature maps. The CNN applies a third batch normalization to the third convolved tensor, thereby generating a third normalized tensor. The CNN also applies a parallel convolution to the second input tensor, the parallel convolution comprising convolving the second input tensor with 256 1 by 1 filters having a stride of 1, thereby generating a parallel convolved tensor. This convolution step produces 256 feature maps. The CNN applies a parallel batch normalization and ReLU activation to the parallel convolved tensor, thereby generating a parallel normalized tensor. The CNN adds the parallel normalized tensor to the third normalized tensor to generate a third input tensor. The third convolution comprises 256 by 3 filters and as such, 256 feature maps are generated by the first convolution block 304.

The CNN then applies a first identity sub-block 306A to the third input tensor. In this sub-block 306A, the first convolution comprises convolving the third input tensor with 64 1 by 1 filters having a stride of 1, thereby producing a first convolved tensor. This convolution step produces 64 feature maps. The CNN applies a first batch normalization and ReLU activation to the first convolved tensor, thereby generating a first normalized tensor. The CNN applies a second convolution to the first normalized tensor, the second convolution comprising convolving the first normalized tensor with 64 3 by 3 filters having a stride of 1 and zero-padding to the same size as the first normalised tensor, thereby generating a second convolved tensor. This convolution step produces 64 feature maps. The CNN applies a second batch normalization and ReLU activation to the second convolved tensor, thereby generating a second normalized tensor. The CNN applies a third convolution to the second normalized tensor, the third convolution comprising convolving the second normalized tensor with 256 1 by 1 filters of stride 1, thereby generating a third convolved tensor. This convolution step produces 256 feature maps. The CNN applies a third batch normalization and ReLU activation to the third convolved tensor, thereby generating a third normalized tensor. The CNN adds the third input tensor to the third normalized tensor and applies a ReLU activation, to generate a first intermediate tensor. The CNN then applies another identity sub-block, 306B, to the first intermediate tensor to generate a fourth input tensor. The identity sub-block 306B is identical to the identity sub-block 306A. The third convolution comprises 256 1 by 1 filters and as such, 256 feature maps are generated by the first identity sub-blocks 306A, 306B.

The second convolution block 308 receives the fourth input tensor. The second convolution block 308 is similar to the first convolution block 304. However, the first convolution comprises 128 1 by 1 filters. The second convolution comprises 128 1 by 1 filters. The third convolution comprises 512 1 by 1 filters. The parallel convolution comprises 512 1 by 1 filters. The second convolution block 308 generates a fifth input tensor. The third convolution comprises 512 3 by 3 filters and as such, 512 feature maps are generated by the second convolution block 308. The CNN then applies a second identity sub-block 310A to the fifth input tensor. The second identity sub-block 310A is similar is the first identity sub-block 306A. However, the first convolution comprises 128 1 by 1 filters. The second convolution comprises 128 3 by 3 filters. The third convolution comprises 512 1 by 1 filters. The second identity sub-block 310A generates a second intermediate tensor. The second identity sub-block 310B, identical to the second identity sub-block 310A, receives the second intermediate tensor and generates a third intermediate tensor. The second identity sub-block 310C, identical to the second identity sub-block 310A, receives the third intermediate tensor and generates a sixth input tensor. The third convolution comprises 512 1 by 1 filters and as such, 512 feature maps are generated by the second identity sub-blocks 310A, 310B, 310C.

The third convolution block 312 receives the sixth input tensor. The third convolution block 312 is similar to the first convolution block 304. However, the first convolution comprises 256 1 by 1 filters. The second convolution comprises 256 1 by 1 filters. The third convolution comprises 1024 3 by 3 filters. The parallel convolution comprises 1024 1 by 1 filters. The third convolution block 312 generates a seventh input tensor. The third convolution comprises 1024 1 by 1 filters and as such, 1024 feature maps are generated by the third convolution block 312.

The CNN then applies a third identity sub-block 314A to the seventh input tensor. The third identity sub-block 314A is similar to the first identity sub-block 306A. However, the first convolution comprises 256 1 by 1 filters. The second convolution comprises 256 1 by 1 filters. The third convolution comprises 1024 1 by 1 filters. The third identity sub-block 314A generates a fourth intermediate tensor. The third identity sub-block 314B, identical to the third identity sub-block 314A, receives the fourth intermediate tensor and generates a fifth intermediate tensor. The third identity sub-block 314C, identical to the third identity sub-block 314A, receives the fifth intermediate tensor and generates a fifth intermediate tensor. The third identity sub-block 314D, identical to the third identity block 314A, receives the fifth intermediate input tensor and generates a sixth intermediate tensor. The third identity sub-block 314E, identical to the third identity block 314A, receives the sixth intermediate input tensor and generates the set of input feature maps. The third convolution comprises 1024 1 by 1 filters and as such, 1024 feature maps are generated by the third identity blocks 314A, 314B, 314C, 314D, 314E.

FIG. 4 shows the region proposal protocol 400 for execution on the set of input feature maps generated by the third identity sub-block 314E. The region proposal protocol 400 comprises an intermediate layer 402, a regression layer 404, and a classification layer 406.

The intermediate layer 402 is configured to generate a set of convolved feature maps suitable for proposal generation, by performing convolutions on the set of input feature maps. In the convolution layer 402 of the region proposal protocol 400, the RPN applies convolutions. In the present example, the convolution comprises convolving each feature map with 512 3 by 3 filters of stride 1, with zero-padding to the same size as the input feature maps. The convolution layer 402 thereby generates a set of convolved feature maps. In the present example, 512 feature maps are generated.

The regression layer 404 is configured to produce a plurality of bounding boxes on each point of each feature map. In particular, the regression layer 404 is configured to produce a number of different bounding boxes on each point of each feature map, wherein each bounding box has one of a number of possible aspect ratio values and one of a number of possible scaling values. Each bounding box has four parameters, including: an x-coordinate, a y-coordinate, a box width, and a box height. Therefore, the regression layer 404 performs a convolution using a number of 1 by 1 filters, with a stride of 1, to produce a set of region proposal coordinates. In the present example, three aspect ratios and three scaling values are proposed, resulting in 3×3×4=36 convolution filters to obtain 9 bounding boxes associated with each point in the input feature map set.

The classification layer 406 is configured to provide an indication as to whether an object of concern is present in each of the bounding boxes generated by the regression block 406. In particular, the classification layer 406 is configured to output a value from 0 to 1, the value corresponding to a confidence that there is an object of concern present at a particular point of the feature map. A ‘0’ is indicative of there being no object of concern at the point in the feature map, and a ‘1’ is indicative of there being an object of concern at the point in the feature map. Accordingly, 9 proposals are generated for each point of the feature map, wherein the proposal is either a ‘0’ or a ‘1’. In the present example, the classification layer 406 performs a convolution using 9 convolution kernels, having a size of 1 by 1.

FIG. 5 depicts the object presence determination method 214.

In a first step 214A, the computing device 102 inputs a region of interest (ROI) match determined in step 212 of the method 200 to a classification layer. The computing device 102 also inputs the first feature maps and the second feature maps determined in steps 206A and 206B of the method 200 to the classification layer.

At step 214B′, the computing device 102 crops an area of each of the first feature maps corresponding to the first ROI of the ROI match.

At step 214B″, the computing device 102 crops an area of each of the second feature maps corresponding to the second ROI of the ROI match.

Steps 214A, 214B′, and 214B″ are repeated for each ROI match.

At step 214C′, the computing device 102 generates a first pooled ROI set. In particular, the computing device 102 generates a four dimensional tensor, the dimensions corresponding to: the number of first regions of interest, a pre-determined length, a pre-determined width, and the number of first feature maps.

At step 214C″, the computing device 102 generates a second pooled ROI set. In particular, the computing device 102 generates a four dimensional tensor, the dimensions corresponding to: the number of second regions of interest, a pre-determined length, a pre-determined width, and the number of second feature maps.

The following steps 214D′, 214E′, and 214F′ are repeated for each first pooled ROI in the first pooled ROI set. Similarly, steps 214D″, 214E″, and 214F″ are repeated for each second pooled ROI in the second pooled ROI set.

At step 214D′, the computing device 102 convolves a pooled ROI of the first pooled ROI set through a classifier convolution block, thereby highlighting features indicating the presence of an object of concern in that pooled ROI. In particular, the classifier convolution block receives a tensor corresponding to the pooled ROI. The classifier convolution block is similar to the first feature map generation convolution block 304. However, for the classifier convolution block, the first convolution comprises 512 1 by 1 filters, the second convolution comprises 512 3 by 3 filters, and the third convolution comprises 2048 1 by 1 filters, and the parallel convolution comprises 2048 1 by 1 filters. The classifier convolution block generates a first classifier convolved tensor for the pooled ROI in the first view. The third convolution comprises 2048 1 by 1 filters and as such, 2048 filtered maps are generated by the classifier convolution block for the pooled ROI.

At step 214D″, the computing device 102 convolves a pooled ROI of the second pooled ROI set, in a substantially similar manner to step 214D′. Accordingly, step 214D″ generates a first classifier convolved tensor for the pooled ROI in the second view.

At step 214E′, the computing devices 102 provides the first classifier convolved tensor for the pooled ROI in the first view to a classifier identity block. The classifier identity block is similar to the first identity block 306. However, the first convolution comprises 512 1 by 1 filters, the second convolution comprises 512 3 by 3 filters, and the third convolution comprises 2048 1 by 1 filters. The classifier identity block is repeated two times in this instance. Step 214E′ generates a second classifier convolved tensor for the pooled ROI for the first view. The third convolution comprises 2048 1 by 1 filters and as such, 2048 filtered maps are generated by step 214E′.

At step 214E″, the computing device 102 passes the first classifier convolved tensor for the pooled ROI in the second view through a classifier identity block substantially similar to step 214E′. Accordingly, step 214″ generates a second classifier convolved tensor for the pooled ROI for the second view.

At step 214F′, the computing device 102 passes the second classifier convolved tensor for the pooled ROI for the first view through a 2D Average Pooling layer. This layer has kernel size 7 by 7. Accordingly, step 214F′ provides a third classifier convolved tensor for the pooled ROI for the first view.

At step 214F″, the computing device 102 passes the second classifier convolved tensor for the pooled ROI for the second view through a 2D Average Pooling layer. This layer has kernel size 7 by 7. Accordingly, step 214F′ provides a third classifier convolved tensor for each pooled ROI for the second view.

At step 214G, the computing device 102 concatenates the first ROI with the respective second ROI of each the ROI matches. In particular, the computing device 102 concatenates or adjoins the third classifier convolved tensor for each pooled ROI match along the convolutional filter channel axis of the convolved tensor. In this way, tensors associated with those regions which were matched in step 212 (i.e. matches of first and second view regions which are co-spatial along the length axis of the volume) are now concatenated.

At step 214H, the computing device 102 flattens the output of step 214G. In particular, the computing device 102 converts the multi-dimensional tensor for each concatenated ROI match of step 214G to a one-dimensional vector having an equal number of elements to the multi-dimensional tensor. This flattening is achieved by converting the concatenated tensor into a vector with columns stacked sequentially.

At step 214I, the computing device 102 provides the flattened vector for each concatenated ROI match into two pre-trained final layers, which are in parallel. The first final layer is a fully connected classifier layer with two neurons and a softmax activation function. The second final layer is a fully connected regression layer with six neurons and a linear activation function. The classifier layer generates two scores, each score ranging from zero to one, the scores indicating the presence of an object of concern or the presence of background within the ROI, respectively. The scores sum to one. The box regression layer is configured to output six box regression coordinates, with the coordinates shared along the length axis of the volume.

At step 214J, the computing device 102 generates an object presence indication based on the classifier layer output for each ROI. For each ROI, the computing device 102 also generates a position on the respective first image and second image at which the object of concern is present based on the output of the classifier layer. The position is generated by taking the regression values from the regression layer output for that ROI, for each dimension, and for the maximum and minimum box extent. The regression values (float values which can be positive or negative), are then added to the values describing the original ROI box, to give a better-refined bounding box for the object of concern. This allows the system to localise the object of concern on the first and second image.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-18. (canceled)

19. An object detection system comprising a computing device in communication with an imaging device, wherein the computing device is configured to:
collect, from the imaging device, a first image captured along a first image axis;
collect, from the imaging device, a second image captured along a second image axis;
generate one or more first feature maps and one or more second feature maps for the first image and the second image respectively;
determine one or more first region proposals and one or more second region proposals based on the one or more first feature maps and the one or more second feature maps respectively;
select one or more first regions of interest from the one or more first region proposals;
select one or more second regions of interest from the one or more second region proposals;
match the first regions of interest with corresponding second regions of interest; and
determine the presence of an object of concern based on the combined region of interest and the feature maps.

20. The system of claim 19, wherein the imaging device is a dual view imaging device.

21. The system of claim 20, wherein the imaging device is an x-ray imaging device.

22. The system of claim 19, wherein the first image is a two-dimensional image having a first dimension and a second dimension; and the second image is a two-dimensional image having the second dimension and a third dimension.

23. The system of claim 19, wherein the one or more first and second feature maps are generated by inputting the first and second images to at least one convolutional neural network, said convolutional neural network being configured to generate the one or more first and second feature maps.

24. The system of claim 19, wherein the one or more first and second region proposals are determined by inputting the first and second feature maps to a region proposal network, said region proposal network being configured to generate the one or more first and second region proposals based on the first and second feature maps, respectively.

25. The system of claim 24, wherein the one or more first and second region proposals each comprise a corresponding target object probability and bounding box indicative of the presence of a target object, said target object being an object of concern.

26. The system of claim 19, wherein the one or more first and second regions of interest are selected by applying a filter to the one or more first and second region proposals.

27. The system of claim 26, wherein the filter is a non-maximum suppression filter.

28. The system of claim 19, wherein a matching the first regions of interest with corresponding second regions of interest is based on a shared second dimension.

29. The system of claim 28, wherein matching the first regions of interest with the corresponding second regions of interest comprises, for each possible match:
determining, for the first region of interest, a minimum axis value and a maximum axis value of the second dimension;
determining, for the second region of interest, a minimum axis value and a maximum axis value of the second dimension;
determining a minimum axis value difference between the minimum axis value of the first region and a minimum axis value of the second region;
determining a maximum axis value difference between the maximum axis value of the first region and a maximum axis value of the second region;
determining a sum of the minimum axis value difference and the maximum axis value difference;
matching the first region of interest with the second region of interest based on a matching condition being met; and
determining, for each match, the minimum and maximum axis value in the second dimension such that they are equal for the first and second regions.

30. The system of claim 29, wherein the matching condition is a minimisation of the sum.

31. The system of claim 29, wherein the minimum axis value of each match of first and second regions are determined by averaging, via the mean, the minimum value for the first region and the minimum value for the second region.

32. The system of claim 29, wherein the maximum axis value of each match of first and second regions are determined by averaging, via the mean, the maximum value for the first region and the maximum value for the second region.

33. The system of claim 29, wherein the presence of an object of concern is determined by:
providing, to a classifier:
the one or more first regions of interest;
the one or more first feature maps;
the one or more second regions of interest; and
the one or more second feature maps;
cropping and dynamically pooling, by the classifier, the one or more first regions of interest from the one or more first feature maps, thereby generating one or more first pooled regions of interest;
cropping and dynamically pooling, by the classifier, the one or more second regions of interest from the one or more second feature maps, thereby generating one or more second pooled regions of interest;
convolving, by the classifier, the one or more first pooled regions of interest with a 2-dimensional convolution block;
convolving, by the classifier, the one or more second pooled regions of interest with a 2-dimensional convolution block;
concatenating, by the classifier, each of the one or more convolved first pooled regions of interest with each of the convolved second pooled regions of interest;
flattening, by the classifier, each of the concatenated and convolved first and second pooled regions of interest; and
classifying, by the classifier, each of the flattened, concatenated and convolved first and second pooled regions of interest; wherein each classification provides an indication as to whether and where an object of concern is present in the captured first and second images.

34. The system of claim 31, wherein the cropping and dynamical pooling steps are achieved via spatial pyramid pooling.

35. The system of claim 29, wherein the object of concern is an explosive object.

36. An object detection method performed by a computing device, comprising the steps of:
collecting, from an imaging device, a first image captured along a first image axis;
collecting, from the imaging device, a second image captured along a second image axis;
generating one or more first feature maps and one or more second feature maps for the first image and the second image respectively;
determining one or more first region proposals and one or more second region proposals based on the one or more first feature maps and the one or more second feature maps respectively;
selecting one or more first regions of interest from the one or more first region proposals;
selecting one or more second regions of interest from the one or more second region proposals;
matching the first regions of interest with corresponding second regions of interest; and
determining the presence of an object of concern based on the combined region of interest and feature maps.
